(19) United States
(12) Patent Application Publication
(10) Pub. No.: US 2026/0094592 A1
(43) Pub. Date: Apr. 2, 2026

(54) PERCUSSION INSTRUMENT

(71) Applicant: YAMAHA CORPORATION, Hamamatsu-shi (JP)

(72) Inventor: Keizo HARADA, Hamamatsu-shi (JP)

(21) Appl. No.: 19/328,911

(22) Filed: Sep. 15, 2025

(30) Foreign Application Priority Data
Sep. 27, 2024 (JP) 2024-168720

(51) Int. Cl. G10H 3/14; G10D 13/10

(52) U.S. Cl. CPC G10H 3/146; G10D 13/26; G10H 2220/461; G10H 2230/301

(57) ABSTRACT

A percussion instrument includes a body portion having a cylindrical shape. The body portion has an opening on a first side of the body portion in an axial direction to which a head is attached. The percussion instrument further includes a rim sensor configured to detect an impact on a rim portion of the body portion. The percussion instrument further includes a head sensor configured to detect an impact on the head. The percussion instrument further includes a support portion supporting the rim sensor and being located within the body portion while being spaced apart from a wall of the body portion when viewed from the axial direction. The support portion is also spaced apart from the head to be attached toward another side in the axial direction. The support portion faces the head in the axial direction. The percussion instrument further includes a plurality of connection portions.

### CROSS-REFERENCE TO RELATED APPLICATIONS

The present application claims priority to Japanese Patent Application No. 2024-168720, filed September 27, 2024. The contents of the application are incorporated herein by reference.

### BACKGROUND

### TECHNICAL FIELD

The present disclosure relates to a percussion instrument.

### BACKGROUND ART

Japanese Unexamined Patent Publication, First Publication No. 2021-105702 A (hereinafter Patent document 1) discloses a percussion instrument (electronic percussion instrument) having a bowl-shaped drum body (body and frame) with one open end and a head attached to the open end of the drum body. In addition, in the percussion instrument of Patent document 1, a rim sensor that detects an impact on the rim portion corresponding to the open end of the drum body, and a head sensor that contacts the head and detects a strike on the head, are attached to the part of the drum body (frame) facing the head.

### SUMMARY

However, in the percussion instrument of Patent document 1, the drum body does not have an opening portion connected to the outside other than the open end covered by the head. This causes a problem in that the feel of the head (the sensation the player feels when striking the head) changes depending on the material of the head attached to the drum body. For example, a non-breathable head made of a non-perforated film material will transmit a greater repulsive force from the head to the stick at the moment the head is struck, compared to a breathable head made of a mesh material.

The present disclosure has been made in consideration of the above-mentioned circumstances. An object of the present disclosure is to provide a percussion instrument that can suppress changes in the feel of the head caused by the head material, thereby improving playability.

One aspect of the present disclosure is a percussion instrument including: a body portion having a cylindrical shape, the body portion having an opening on a first side of the body portion in an axial direction, to which a head is attached; a rim sensor configured to detect an impact on a rim portion of the body portion; a head sensor configured to detect an impact on the head; a support portion supporting the rim sensor and being located within the body portion while being spaced apart from a wall of the body portion when viewed from the axial direction, the support portion also being spaced apart from the head and facing the head in the axial direction; a plurality of connection portions, each of the plurality of connection portions extending from the support portion to the body portion and connecting the support portion and the body portion, the plurality of connection portions being arranged at intervals in a circumferential direction of the body portion; and a plurality of opening portions that open to a second side of the body portion opposite to the first side of the body portion in the axial direction and that are respectively disposed between each of the plurality of connection portions, wherein the head sensor is attached to at least one connection portion of the plurality of connection portions and contacts the head.

### BRIEF DESCRIPTION OF THE DRAWINGS

FIG. 1 is a perspective view showing the external appearance of a percussion instrument according to one embodiment of the present disclosure.

FIG. 2 is an exploded perspective view showing the percussion instrument of FIG. 1 with the head and hoop removed from the body.

FIG. 3 is a perspective view showing the configuration of the percussion instrument of FIG. 1 without the head and hoop.

FIG. 4 is a plan view of the configuration of FIG. 3 as viewed from the open end side of the body.

FIG. 5 is an exploded perspective view of the configuration of FIG. 3.

FIG. 6 is a perspective view of the configuration of FIG. 3 with the rim sensor, head sensor, control board, second reinforcing member, and clamping structure removed.

FIG. 7 is a plan view of the configuration of FIG. 6 as viewed from the open end side of the body.

FIG. 8 is a cross-sectional view taken along the line IX-IX in FIG. 4.

FIG. 9 is a cross-sectional view taken along the line X-X in FIG. 4.

FIG. 10 is a cross-sectional view taken along the line XI-XI in FIG. 4.

FIG. 11 is a schematic diagram of main parts of a percussion instrument according to another embodiment of the present disclosure.

FIG. 12 is a diagram showing the percussion instrument of FIG. 11 with the length of the connection portion changed.

FIG. 13 is a cross-sectional view showing main parts of a percussion instrument according to another embodiment of the present disclosure.

### DETAILED DESCRIPTION OF THE EMBODIMENTS

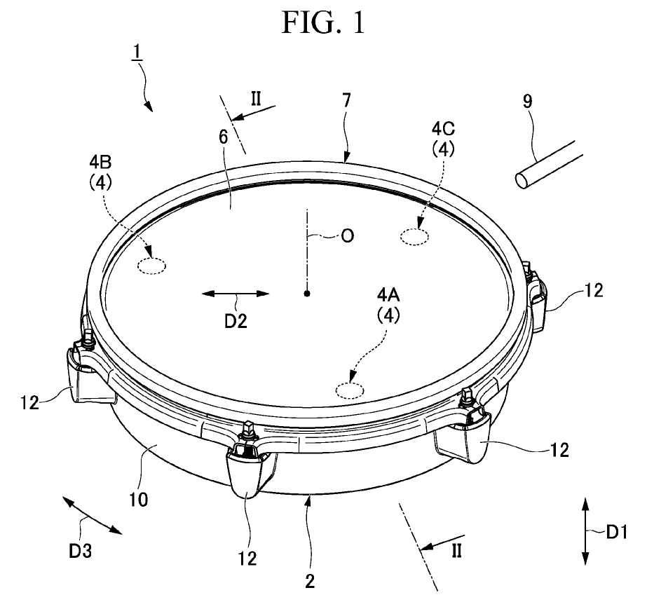

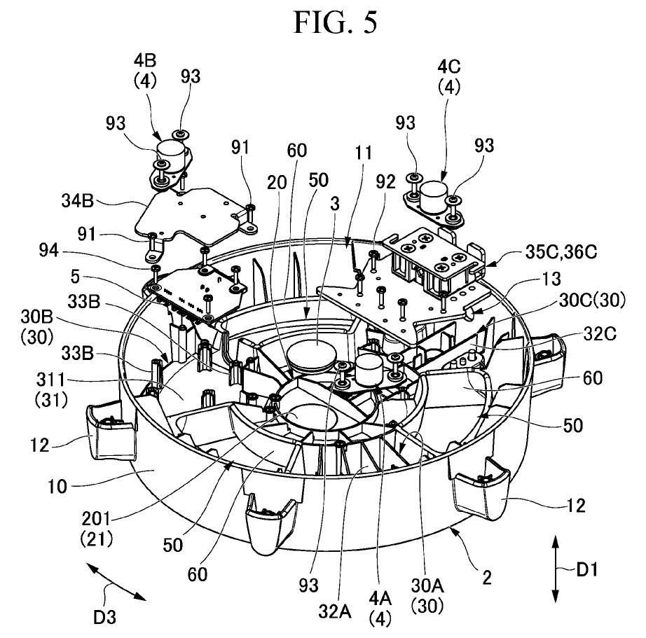

Below, embodiments of the present disclosure will be described with reference to FIG. 1 to FIG. 10.

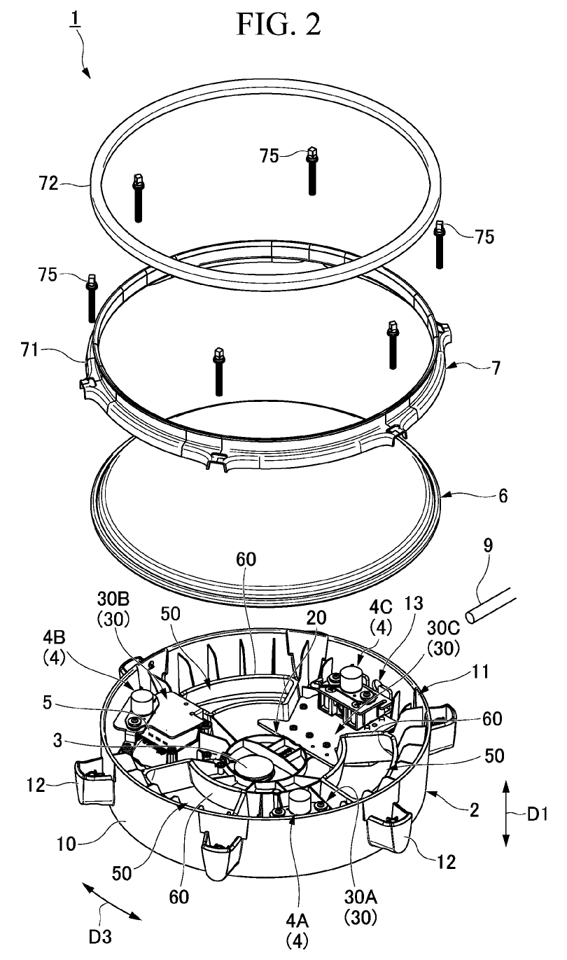

As shown in FIG. 1 and FIG. 2, the percussion instrument 1 of this embodiment is a drum, and includes a drum body 2, a rim sensor 3, head sensors 4, and a control board 5. Moreover the percussion instrument 1 of this embodiment also includes a head 6 and a hoop 7.

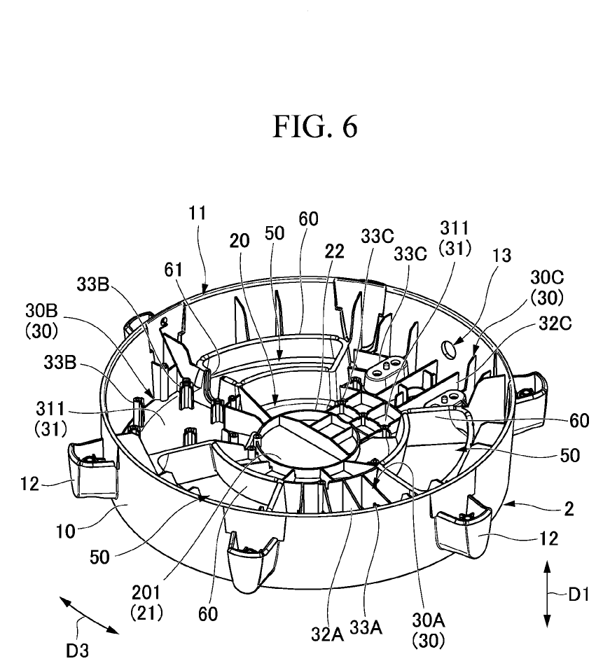

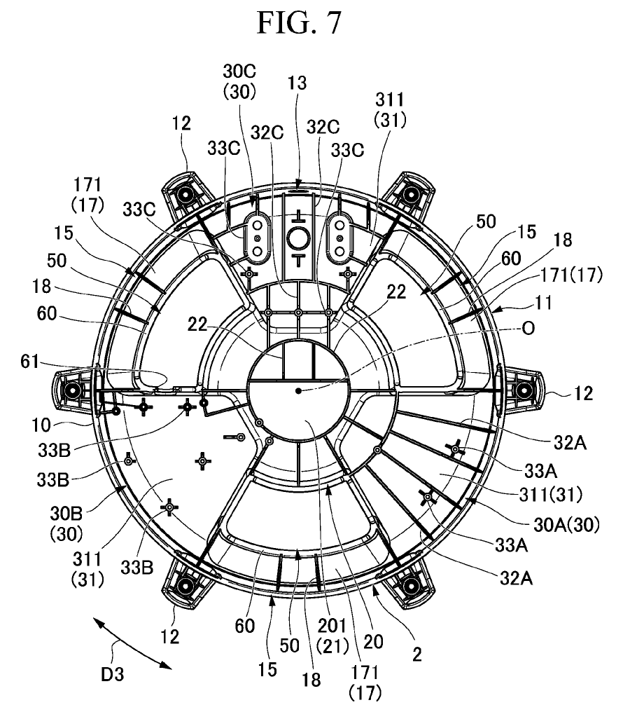

As shown in FIG. 2, FIG. 6, and FIG. 7, the drum body 2 has one open end 11 to which the head 6 is attached. The drum body 2 includes a body portion 10, a support portion 20, a plurality of connection portions 30, a plurality of opening portions 50, and a protective portion 60.

The body portion 10 is formed in a tubular or ring shape. Specifically, the body portion 10 is formed in a cylindrical shape. In the following description, the direction in which the axis O of the cylindrical body portion 10 extends is called the axial direction D1. The radial direction of the axis O is called the radial direction D2 (see FIG. 1). Moreover, the direction around the axis O is called the circumferential direction D3. The opening on one side of the body portion 10 in the axial direction D1 (the upper side in FIG. 2 and FIG. 6) is the open end 11 to which the head 6 is attached.

In this embodiment, a plurality of lugs 12 are provided on the outer circumferential surface of the body portion 10. Moreover, the body portion 10 is also formed with one through hole 13 that penetrates in the radial direction D2.

As shown in FIG. 1 and FIG. 2, the head 6 is formed in a circular shape corresponding to the shape of the open end 11 of the body portion 10 as viewed from the axial direction D1, and is attached to the open end 11 of the body portion 10 so as to cover the open end 11 of the body portion 10. The material of the head 6 may be, for example, a mesh material, a rubber material, a film material, or the like.

The hoop 7 is formed in a circular ring shape corresponding to the open end 11 of the body portion 10. The hoop 7 is fitted to the open end 11 of the body portion 10 by inserting a plurality of lug bolts 75 therethrough and screwing them into the plurality of the lugs 12 of the body portion 10. Furthermore, by attaching the hoop 7 to the open end 11 of the body portion 10 in this manner, the head 6 is pressed against the open end 11 of the body portion 10 by the hoop 7, and the head 6 is attached to the body portion 10. The hoop 7 constitutes a rim portion corresponding to the open end 11 of the body portion 10.

The hoop 7 of this embodiment has an annular hoop body 71 having a plurality of insertion holes for inserting the lug bolts 75, and an annular hoop cover 72 attached to the hoop body 71 and covering the hoop body 71. The hoop body 71 may be made of, for example, metal or resin. The hoop cover 72 is a component intended to protect the hoop body 71 and may be made of, for example, rubber. The hoop 7 may be composed of, for example, only the hoop body 71.

As shown in FIG. 2, FIG. 6, and FIG. 7, the support portion 20 is located on the inside of the body portion 10 with a gap when viewed from the axial direction D1. Moreover, the support portion 20 is located on the other side in the axial direction D1 (the lower side in FIG. 2 and FIG. 6) with a gap therebetween from the head 6 (the open end 11 of the body portion 10). The support portion 20 faces the head 6 in the axial direction D1 and supports the rim sensor 3. Specifically, the support portion 20 has a support surface 201 that faces the head 6 in the axial direction D1 and supports the rim sensor 3.

The support portion 20 in the illustrated example is generally circular in plan view when viewed from the axial direction D1, but the shape of the support portion 20 in plan view may be arbitrary. Also, the support portion 20 in the illustrated example is located in the central part of the body portion 10 through which the axis O passes when viewed from the axial direction D1, but may be located, for example, shifted from the central part in the radial direction D2.

The support portion 20 has a support portion main body 21 that includes the support surface 201, and a rib 22 that protrudes from the support surface 201 and extends in a direction along the support surface 201. The support portion main body 21 is formed in a plate shape with the plate thickness direction mainly in the axial direction D1, and the rib 22 has the role of reinforcing the plate-shaped support portion main body 21. The rib 22 is located so as not to interfere with the rim sensor 3. The shape, arrangement, and number of the ribs 22 formed on the support portion 20 are not limited to those shown in the illustrated example. Note that if the strength of the support portion main body 21 is sufficient, the support portion 20 may not have the ribs 22. Some of the ribs 22 of the support portion 20 are connected to ribs (first rib 32A, third rib 32C) of the connection portion 30 described later.

As shown in FIG. 2 to FIG. 4, the plurality of connection portions 30 each extend from the support portion 20 to the body portion 10 and connect the support portion 20 and the body portion 10. The plurality of connection portions 30 are arranged at intervals around the circumferential direction D3 of the body portion 10. In this embodiment, the plurality of connection portions 30 are arranged at equal intervals around the circumferential direction D3 of the body portion 10. Furthermore, the dimensions (angle range) of the connection portions 30 in the circumferential direction D3 are equal among the plurality of connection portions 30. The number of connection portions 30 in this embodiment is three. Hereinafter, the three connection portions 30 may be referred to as the first connection portion 30A, the second connection portion 30B, and the third connection portion 30C, respectively.

As shown in FIG. 2, FIG. 6, and FIG. 7, each connection portion 30 has a connection plate portion 31. The connection plate portions 31 are formed in a plate shape with the plate thickness direction mainly in the axial direction D1, and extend from the support portion 20 to the body portion 10. The connection plate portions 31 in the illustrated example are formed in a fan shape centered on the axis line O, but are not limited to this. In this embodiment, the connection plate portions 31 are formed integrally with the body portion 10 and the support portion 20.

As shown in FIG. 2, and FIG. 6 to FIG. 8, the first connection portion 30A further has a first rib 32A and a first boss 33A in addition to the connection plate portion 31. The first rib 32A and the first boss 33A both protrude from the opposing surface 311 of the connecting plate portion 31 that faces the head 6 (the open end 11 of the body portion 10). The first rib 32A and the first boss 33A have the role of reinforcing the connecting plate portion 31. The first rib 32A and the first boss 33A are formed integrally with the connecting plate portion 31.

The first rib 32A extends from the support portion 20 to the body portion 10 along the opposing surface 311 of the connecting plate portion 31. Specifically, the first rib 32A mainly extends linearly in the radial direction from the support portion 20 to the body portion 10. The first ribs 32A are severally arranged at intervals around the circumferential direction D3.

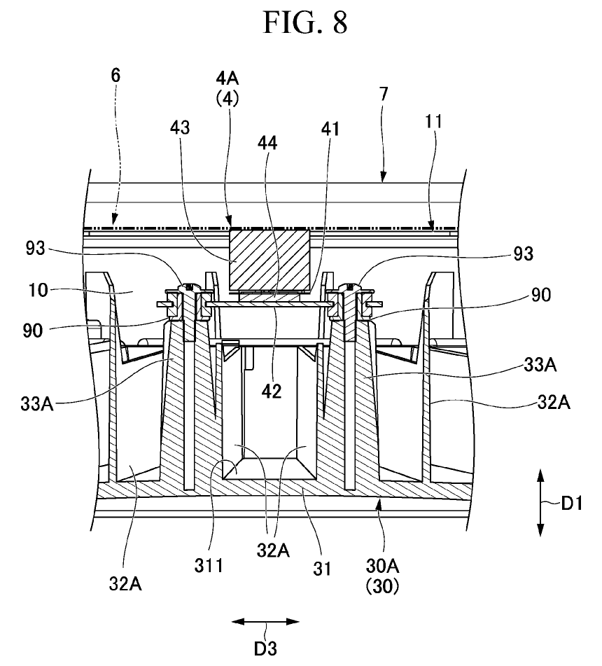

The first boss 33A is disposed at a position closer to the body portion 10 than the support portion 20 in the radial direction D2. In FIG. 8, the height dimension of the first boss 33A in the axial direction D1 is lower than the height dimension of the first rib 32A. The two first bosses 33A are arranged side by side at an interval in the circumferential direction D3. The two first bosses 33A also serve to attach the head sensor 4, which will be described later, to the first connection portion 30A.

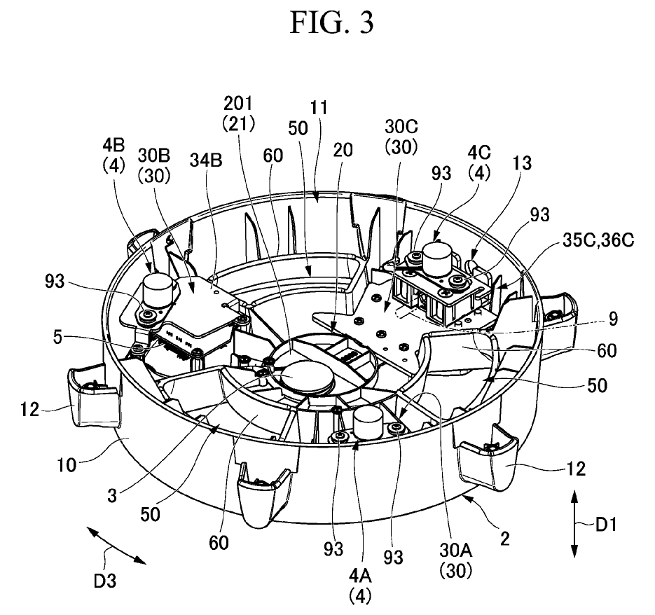

As shown in FIG. 3 to FIG. 7 and FIG. 9, the second connection portion 30B further includes a second reinforcing member 34B and a plurality of second bosses 33B in addition to the connection plate portion 31. The second reinforcing member 34B is disposed on the opposing surface 311 side of the connection plate portion 31 that faces the head 6 (open end 11 of the body portion 10), and is fixed to the connection plate portion 31 by fixing members 91. The plurality of second bosses 33B protrude from the opposing surface 311 of the connection plate portion 31. The plurality of second bosses 33B are formed integrally with the connection plate portion 31. Some of the plurality of second bosses 33B have a high protruding height, while others have a low protruding height.

The second reinforcing member 34B in this embodiment is formed in a flat plate shape. The second reinforcing member 34B is arranged so that its plate thickness direction faces the axial direction D1. Specifically, the second reinforcing member 34B is arranged at the tip of a plurality of second bosses 33B with a high protruding height. Moreover, the second reinforcing member 34B is fixed to the tip of the plurality of second bosses 33B by screws serving as fixing members 91. The second reinforcing member 34B arranged in this manner plays a role in reinforcing the connecting plate portion 31.

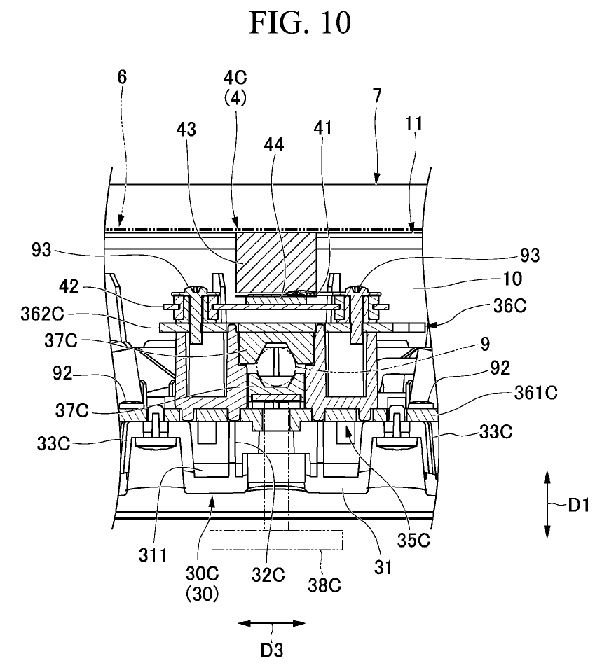

As shown in FIG. 3 to FIG. 7, and FIG. 10, the third connecting portion 30C is located in the circumferential direction D3 in correspondence with the portion of the body portion 10 where the through hole 13 is formed. In addition to the connecting plate portion 31, the third connecting portion 30C further has a third rib 32C, a third boss 33C, and a clamping structure 35C. As shown in FIG. 6, FIG. 7, and FIG. 10, the third rib 32C and the third boss 33C both protrude from the opposing surface 311 of the connecting plate portion 31 that faces the head 6 (open end 11 of the body portion 10). The third rib 32C and the third boss 33C serve to reinforce the connecting plate portion 31. The third rib 32C and the third boss 33C are formed integrally with the connecting plate portion 31.

The third rib 32C extends from the support portion 20 to the body portion 10 along the opposing surface 311 of the connecting plate portion 31. Specifically, the third rib 32C extends from the support portion 20 to the body portion 10 while bending. In addition, the plurality of third ribs 32C intersect and are connected to each other when viewed from the axial direction D1.

The plurality of third bosses 33C are arranged at intervals along the opposing surface 311 of the connecting plate portion 31. The plurality of third bosses 33C also serve to attach the clamping structure 35C to the connecting plate portion 31. Some of the third bosses 33C are connected to the third ribs 32C, or are formed integrally with the third ribs 32C.

As shown in FIG. 3 to FIG. 5, and FIG. 10, the clamping structure 35C clamps a rod-shaped member 9 inserted from the outside of the body portion 10 through the through hole 13 to the inside of the body portion 10. The rod-shaped member 9 may be, for example, a component of a drum stand to which the percussion instrument 1 is attached.

As shown in FIG. 10, the clamping structure 35C includes a housing 36C, two clamping members 37C, and a tightening screw 38C. The two clamping members 37C are members that clamp the rod-shaped member 9. One of the clamping members 37C is held immovably relative to the housing 36C. The other clamping member 37C is held movable within a predetermined range relative to the housing 36C. The other clamping member 37C is allowed to move away from or approach the one clamping member 37C within a predetermined range. The fastening screw 38C is screwed into the housing 36C. By rotating the fastening screw 38C relative to the housing 36C, the other clamping member 37C can be brought closer to the one clamping member 37C, and the rod-shaped member 9 can be clamped by the two clamping members 37C.

As shown in FIG. 3 to FIG. 5, and FIG. 10, the housing 36C is fixed to the connecting plate portion 31 by fixing members 92. Specifically, a first plate member 361C constituting the housing 36C is disposed at the tips of the plurality of third bosses 33C. Then the first plate member 361C is fixed to the tips of the plurality of third bosses 33C by screws as the fixing members 92. The first plate member 361C covers most of the opposing surface 311 of the connecting plate portion 31 of the third connecting portion 30C. The housing 36C including the first plate member 361C functions as a reinforcing member (third reinforcing member) that reinforces the connecting plate portion 31.

As shown in FIG. 2 and FIG. 7, the plurality of opening portions 50 open on the other side in the axial direction D1 between the connecting portions 30 adjacent to each other in the circumferential direction D3. When viewed from the axial direction D1, each opening portion 50 is surrounded by the body portion 10, the support portion 20, and the two connecting portions 30 aligned in the circumferential direction D3. The opening portions 50 illustrated in FIG. 7 are formed in a fan shape when viewed from the axial direction D1.

The body portion 10 of this embodiment has plurality of reinforcing portions 15 provided between the connecting portions 30 adjacent to each other in the circumferential direction D3. The number of reinforcing portions 15 in this embodiment is three. Each reinforcing portion 15 protrudes radially inward from the main body portion of the cylindrical body portion 10. Each reinforcing portion 15 is formed in an arc shape extending in the circumferential direction D3 along the main body portion of the body portion 10. Both ends of each reinforcing portion 15 in the circumferential direction D3 are connected to the connecting plate portion 31 of the connecting portion 30. Each reinforcing portion 15 faces the support portion 20 through an opening portion 50 in the radial direction D2. The reinforcing portion 15 reinforces the main body portion of the body portion 10.

The reinforcing portion 15 of this embodiment has a strip portion 17 and a plurality of ribs 18. The strip portion 17 is formed in an arc shape extending in the circumferential direction D3 when viewed from the axial direction D1. In FIG. 7, the strip portion 17 is inclined in the axial direction D1 toward the head 6 (open end 11 of the body portion 10) as it moves radially inward from the main body portion of the body portion 10. The ribs 18 each protrude from the opposing surface 171 of the strip portion 17 that faces the head 6 (open end 11 of the body portion 10) and extend in the radial direction D2 along the opposing surface 311. Additionally, the plurality of ribs 18 also each contact the inside of the main body portion of the body portion 10. The plurality of ribs 18 are arranged at intervals in the circumferential direction D3. The plurality of ribs 18 reinforce the main body portion of the body portion and the strip portion 17.

As shown in FIG. 2, FIG. 6, and FIG. 7, the protective portion 60 extends from the edges of the support portion 20 and the connection portion 30 that form the edges of each opening portion 50, to one side (upper side in FIG. 2 and FIG. 6) in the axial direction D1 in a plan view seen from the axial direction D1. That is, the protective portion 60 extends from the edges of the support portion 20 and the connection portion 30 toward the head 6 side (open end 11 of the body portion 10) in the axial direction D1.

In this embodiment, the protective portion 60 also extends to one side in the axial direction D1 from the edge of the reinforcing portion 15 of the body portion 10 that constitutes the edge of each opening portion 50. Therefore, the protective portion 60 is formed so as to surround the opening portion 50 when viewed from the axial direction D1. In addition, the tip of the protective portion 60 is located lower than the open end 11 of the body portion 10. Therefore, the protective portion 60 does not come into contact with the head 6. The protective portion 60 in this embodiment is formed integrally with the body portion 10, the support portion 20, and the connection portion 30.

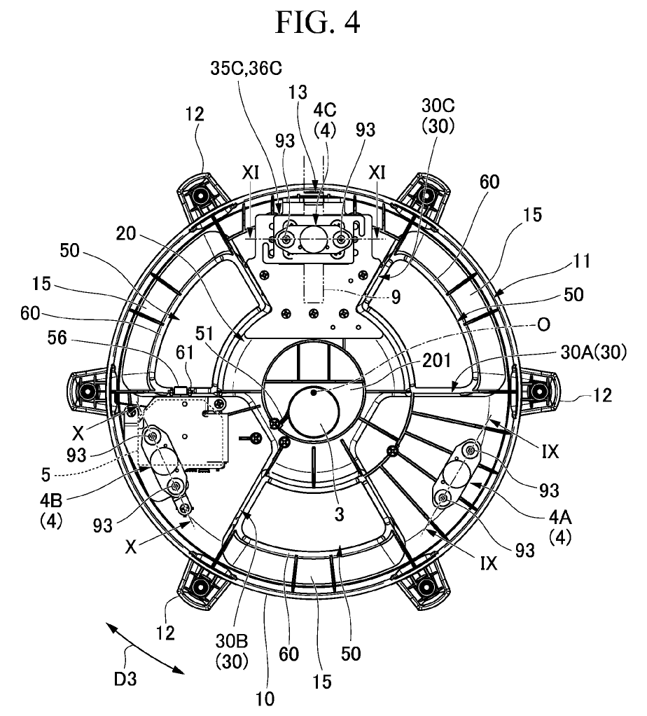

In this embodiment, the protective portion 60 is formed in a plate shape. Also, as shown in FIG. 4 and FIG. 6, some of the protective portions 60 has an exposure hole 61 that penetrates through in the plate thickness direction and exposes the pin jack 56 to the opening portion 50 side. In the illustrated example, the exposure hole 61 is formed in a portion of the protective portion 60 that is located at the connection portion 30, and opens at the tip of the protective portion 60. The pin jack 56 exposed from the exposure hole 61 on the opening portion 50 side is a connection terminal for electrically connecting the sensor circuit including the rim sensor 3, head sensor 4, and control board 5 to the outside.

The protective portion 60 may be formed in a lattice or mesh shape, for example. Moreover, the lattice or mesh protective portion 60 may be formed by combining a plurality of rod-shaped members, for example.

The rim sensor 3 shown in FIG. 2 to FIG. 5 detects a strike on the rim portion corresponding to the open end 11 of the body portion 10. In this embodiment, the rim sensor 3 mainly detects a strike on the hoop 7. Specifically, the rim sensor 3 mainly detects vibrations that occur when the hoop 7 is struck. The rim sensor 3 also sends an electrical signal corresponding to the detected vibration to the control board 5, which will be described later.

As shown in FIG. 3 and FIG. 4, the rim sensor 3 is disposed on the support surface 201 of the support portion 20. The rim sensor 3 may be fixed to the support portion 20 by, for example, an adhesive or the like. By attaching the rim sensor 3 to the support portion 20 in this way, when the rim portion is struck, vibrations based on the strike are transmitted in sequence from the body portion 10 to the connection portion 30 and the support portion 20, and reach the rim sensor 3. This enables the rim sensor 3 to detect a strike on the rim portion.

The head sensor 4 shown in FIG. 8 to FIG. 10 detects a strike on the head 6 attached to the open end 11 of the body portion 10. Specifically, the head sensor 4 detects vibrations of the head 6 that occur when the head 6 is struck. The head sensor 4 is attached to the connection portion 30 and comes into contact with the head 6. In this embodiment, a cushioning material 90 that absorbs vibrations of the connection portion 30 is interposed between the head sensor 4 and the connection portion 30.

As shown in FIG. 1 to FIG. 5, the number of head sensors 4 in this embodiment corresponds to the number of connection portions 30, that is, three. These three head sensors 4 are attached to the three connection portions 30, one each. The three head sensors 4 are arranged at equal intervals around the circumferential direction D3. The three head sensors 4 are each located at the middle of the connection portions 30 in the circumferential direction D3. Furthermore, the three head sensors 4 are each located closer to the body portion 10 than the support portion 20 in the radial direction D2.

The number of head sensors 4 in the percussion instrument 1 may be less than the number of connection portions 30 (for example, one). In this case, the head sensor 4 may be attached to some of the connection portions 30.

As shown in FIG. 8 to FIG. 10, the head sensor 4 of this embodiment includes a sensor body 41, a support plate portion 42, and a vibration transmission member 43.

The sensor body 41 detects vibrations of the head 6. Moreover, the sensor body 41 sends an electrical signal corresponding to the detected vibration to the control board 5, which will be described later.

The support plate portion 42 supports the sensor body 41. The sensor body 41 is fixed to a surface of the support plate portion 42 facing one side in the plate thickness direction. The support plate portion 42 is formed in a band-like shape with a predetermined linear direction as the longitudinal direction. The sensor body 41 is located in the middle of the support plate portion 42 in the longitudinal direction. Therefore, both longitudinal ends of the support portion 20 are located on both sides of the sensor body 41.

In this embodiment, a cushioning material 44 is provided between the sensor body 41 and the support plate portion 42. The cushioning material 44 has a property of absorbing vibrations, that is, it has a function of suppressing the transmission of vibrations from the support plate portion 42 to the sensor body 41. Note that the sensor body 41 may be directly fixed to the support plate portion 42, for example.

The support plate portion 42 is fixed to the connection portion 30 by two fixing members 93. Specifically, both longitudinal ends of the support plate portion 42 located on both sides of the sensor body 41 are fixed to the connection portion 30 by two fixing members 93, respectively. These two fixing members 93 are located on both sides of the sensor body 41 in the circumferential direction D3 (see FIG. 4). The fixing members 93 in this embodiment are screws, but may be, for example, an adhesive. The aforementioned cushioning material 90 is interposed between both longitudinal ends of the support plate portion 42 and the connection portion 30. A specific mounting manner of the support plate portion 42 to the first to third connection portions 30A to 30C will be described later.

The vibration transmission member 43 is attached to the sensor body 41 and sandwiches the sensor body 41 between the support plate portion 42. The vibration transmission member 43 contacts both the sensor body 41 and the head 6, and transmits the vibration of the head 6 to the sensor body 41. The vibration transmission member 43 may be an elastic member that elastically deforms, such as a sponge. As a result, when the head 6 is struck, the vibration of the head 6 reaches the sensor body 41 via the vibration transmission member 43, so that the strike to the head 6 can be detected by the sensor body 41.

As shown in FIG. 8 to FIG. 10, a single vibration transmission member 43 may be provided between the sensor body 41 and the head 6, or for example, a plurality of vibration transmission members 43 may be stacked in the direction in which the sensor body 41 and the head 6 are aligned.

It should be noted that the head sensor 4 may for example not include a vibration transmission member 43, and the sensor body 41 may be in direct contact with the head 6.

Below, a specific manner in which the support plate portion 42 of the head sensor 4 is attached to the first to third connection portions 30A to 30C will be described.

As shown in FIG. 8, the support plate portion 42 of the head sensor 4 (first head sensor 4A) attached to the first connection portion 30A is disposed at the tips of the two first bosses 33A of the first connection portion 30A. Then the support plate portion 42 of the first head sensor 4A is fixed to the tips of the two first bosses 33A by screws serving as fixing members 93. In this state, cushioning material 90 is interposed between both ends of the support plate portion 42 of the first head sensor 4A and the two first bosses 33A.

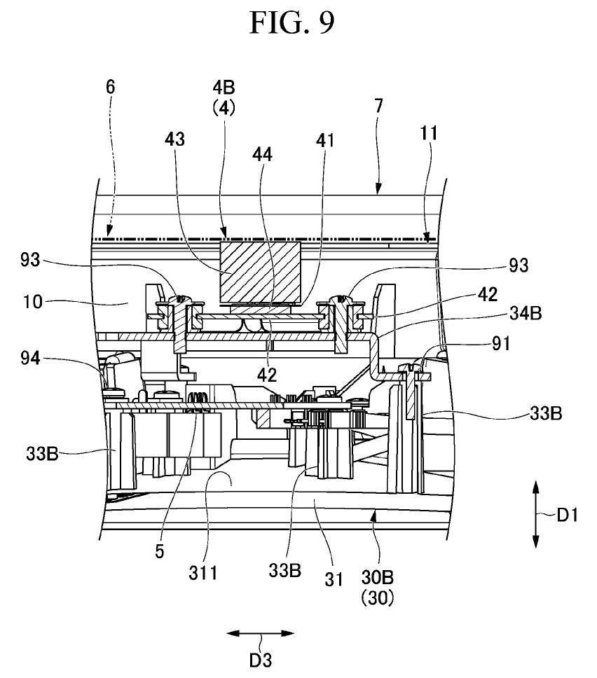

As shown in FIG. 9, the support plate portion 42 of the head sensor 4 (second head sensor 4B) attached to the second connection portion 30B, is disposed at a distance from the surface of the second reinforcing member 34B of the second connection portion 30B that faces the head 6 (open end 11 of the body portion 10) side. The support plate portion 42 of the second head sensor 4B is then fixed to the second reinforcing member 34B by screws serving as fixing members 93. In this state, the cushioning material 90 is interposed between both ends of the support plate portion 42 of the second head sensor 4B and the second reinforcing member 34B.

As shown in FIG. 10, the support plate portion 42 of the head sensor 4 (third head sensor 4C) attached to the third connection portion 30C is disposed at a distance from the surface of the housing 36C (third reinforcing member) of the third connection portion 30C facing the head 6 (open end 11 of the body portion 10) side. Specifically, the support plate portion 42 is disposed at a distance from the second plate member 362C located on the head 6 (open end 11 of the body portion 10) side of the housing 36C. The support plate portion 42 of the third head sensor 4C is then fixed to the housing 36C (second plate member 362C) by screws serving as fixing members 93. In this state, the cushioning material 90 is interposed between both ends of the support plate portion 42 of the third head sensor 4C and the housing 36C.

The control board 5 shown in FIG. 2 to FIG. 5, and FIG. 9 controls the operation of the rim sensor 3 and head sensor 4 described above. Furthermore, the control board 5 appropriately processes the electrical signals sent from the rim sensor 3 and the head sensor 4, and outputs them to an external device through the pin jack 56. The control board 5 is electrically connected to the rim sensor 3, the plurality of head sensors 4, and the pin jack 56 by electrical wiring (not shown).

As shown in FIG. 9, the control board 5 of this embodiment is attached to the second connection portion 30B. Moreover the control board 5 is arranged between the connection plate portion 31 of the second connection portion 30B and the second reinforcing member 34B arranged side by side in the axial direction D1, and is covered by the second reinforcing member 34B.

Specifically, the control board 5 is arranged at the tips of the plurality of second bosses 33B that are short in height. Moreover, the control board 5 is fixed to the tips of the plurality of second bosses 33B by screws serving as fixing members 94. As a result, the control board 5 is disposed between the connection plate portion 31 of the second connection portion 30B and the second reinforcing member 34B. Furthermore, the part of the control board 5 facing the head 6 (open end 11 of the body portion 10) side is covered by the second reinforcing member 34B.

Although not shown, various electrical wirings connecting the rim sensor 3, the head sensor 4, and the pin jack 56 to the control board 5 are disposed in an area overlapping the support portion 20 and the connection portion 30 in the axial direction D1, and are not disposed in a position overlapping the opening portion 50 in the axial direction D1. Moreover, these electrical wirings are disposed on the support surface 201 side of the support portion 20 and the opposing surface 311 side of the connection plate portion 31.

As described above, in the percussion instrument 1 of this embodiment, the opening on one side of the body portion 10 in the axial direction D1 serves as the open end 11 to which the head 6 is attached. Also, the support portion 20 and the plurality of connection portions 30 are located on the other side of the body portion 10 in the axial direction D1. Between each of the connection portions 30 adjacent to each other in the circumferential direction D3, a plurality of opening portions 50 open to the other side in the axial direction D1. Therefore, regardless of the material of the head 6, it is possible to suppress a large difference in the repulsive force transmitted from the head 6 side to the player at the moment the player strikes the head 6. This makes it possible to suppress a change in the striking feeling of the head 6 due to the material of the head 6. Therefore, it is possible to improve the playability of the percussion instrument 1.

Also, by providing a plurality of opening portions 50 at the position of the body portion 10 of the percussion instrument 1 that faces the head 6 in the axial direction D1, the sound can be more easily released when the head 6 is struck.

Furthermore, it is possible to reduce the weight of the percussion instrument 1 compared to a case in which the percussion instrument 1 does not have a plurality of opening portions 50.

Also, it is possible to make contact with the head 6 by passing another head sensor through the opening portion 50. In other words, it is possible to add a head sensor later.

Furthermore, in the percussion instrument 1 of this embodiment, the body portion 10 and the support 20 are connected by a plurality of connection portions 30 arranged at intervals in the circumferential direction D3 of the body portion 10. This makes it possible to suppress variation in the time from when the rim portion (hoop 7) is struck until the vibration corresponding to the strike reaches the rim sensor 3. This point will be explained below.

For example, when the body portion 10 and the support 20 are connected by a single connection portion 30, the distance from the strike position of the rim portion to the support 20 via the connection portion 30 varies greatly depending on the strike position of the rim portion in the circumferential direction D3. For this reason, the time from when the rim portion is struck until the vibration corresponding to the strike reaches the rim sensor 3 varies greatly depending on the strike position of the rim portion in the circumferential direction D3. For example, when the rim portion located close to the connection portion between the body portion 10 and the connection portion 30 in the circumferential direction D3 is struck, the time until the vibration corresponding to the strike on the rim portion reaches the rim sensor 3 is short. On the other hand, when the rim portion located away from the connection portion between the body portion 10 and the connection portion 30 in the circumferential direction D3 is struck, it takes a long time for the vibration corresponding to the strike on the rim portion to reach the rim sensor 3.

In contrast, when the body portion 10 and the support portion 20 are connected by a plurality of connection portions 30 arranged in the circumferential direction D3, the distance from the striking position of the rim portion to the support portion 20 via the vibration portion can be prevented from changing significantly depending on the striking position of the rim portion in the circumferential direction D3 of the body portion 10. This makes it possible to reduce the variation in the time from striking the rim portion to the time when the vibration corresponding to the strike reaches the rim sensor 3 depending on the striking position of the rim portion in the circumferential direction D3 of the body portion 10.

Furthermore, in the percussion instrument 1 of this embodiment, a plurality of connection portions 30 are arranged at equal intervals in the circumferential direction D3, and the dimensions (angle range) of the connection portions 30 in the circumferential direction D3 are equal among the a plurality of connection portions 30. This makes it possible to further reduce the variation in the time from striking the rim portion to the time when the vibration corresponding to the strike reaches the rim sensor 3.

Moreover, in the percussion instrument 1 of this embodiment, the first connection portion 30A and the third connection portion 30C each have a connection plate portion 31 extending from the support portion 20 to the body portion 10, and a rib (first rib 32A, third rib 32C) protruding from the opposing surface 311 of the connection plate portion 31 and extending from the support portion 20 to the body portion 10. Therefore, the connection plate portion 31 can be reinforced by the rib, and the strength of the first connection portion 30A and the third connection portion 30C can be improved.

Furthermore, in the percussion instrument 1 of this embodiment, the second connection portion 30B and the third connection portion 30C each have a connection plate portion 31 extending from the support portion 20 to the body portion 10, and a reinforcing member (second reinforcing member 34B, housing 36C) arranged on the opposing surface 311 side of the connection plate portion 31. Therefore, the connecting plate portion 31 can be reinforced by the reinforcing member, and the strength of the second connecting portion 30B and the third connecting portion 30C can be improved.

Moreover, in the percussion instrument 1 of this embodiment, the control board 5 is disposed between the connecting plate portion 31 of the second connecting portion 30B and the second reinforcing member 34B, and is covered by the second reinforcing member 34B. Thereby the control board 5 can be protected by the second reinforcing member 34B. The configuration in which the control board 5 is covered by the second reinforcing member 34B is particularly effective when the head 6 is removed from the open end 11 of the body portion 10.

Furthermore, because the second reinforcing member 34B serves both to reinforce the connecting plate portion 31 and to protect the control board 5, it is possible to allow the number of components of the percussion instrument 1 to be reduced.

Moreover, the percussion instrument 1 of this embodiment further includes a protective section 60 that extends from the edge of the support section 20 and the connection section 30 that form the edge of the opening portion 50 toward the head 6 (open end 11 of the body section 10) side in a plan view seen from the axial direction D1. Therefore, even if the user's hand or the like enters the inside of the body section 10 through the opening portion 50, the protective section 60 can prevent it from reaching the rim sensor 3, the head sensor 4, the control board 5, the electrical wiring, etc., that are located at the position of the support section 20 and the connection section 30 that faces the head 6. In addition, if the electrical wiring that connects the rim sensor 3, the head sensor 4, and the pin jack 56 to the control board 5 is located at the position of the support section 20 and the connection section 30 that faces the head 6, the protective section 60 can also prevent the user's hand or the like from reaching the electrical wiring. Therefore, even if the size of the opening portion 50 seen from the axial direction D1 is large, the rim sensor 3, the head sensor 4, the control board 5, the electrical wiring, etc. can be protected.

In addition, in the percussion instrument 1 of this embodiment, a cushioning material 90 that absorbs vibrations of the connection portion 30 is interposed between the head sensor 4 and the connection portion 30. This makes it possible to prevent vibrations corresponding to strikes on the rim portion from being detected by the head sensor 4. This point will be explained below.

When the rim portion is struck, the vibrations corresponding to the strike travel from the body portion 10 through the connection portion 30 and the support portion 20 in this order to the rim sensor 3, and the rim sensor 3 detects the strike on the rim portion. Although the vibrations corresponding to the strike on the rim portion also are transmitted from the connection portion 30 to the head sensor 4, they are absorbed by the cushioning material 90, so that they are prevented from reaching the head sensor 4. This makes it possible to prevent vibrations corresponding to a strike on the rim portion from being detected by the head sensor 4.

In addition, in the percussion instrument 1 of this embodiment, the cushioning material 44 that absorbs vibrations of the connection portion 30 is interposed between the sensor body 41 and the support plate portion 42 of the head sensor 4. Therefore, even if vibrations corresponding to striking the rim portion are transmitted from the connection portion 30 to the support plate portion 42 of the head sensor 4, the vibrations can be absorbed by the cushioning material 44. This can prevent the vibrations from reaching the sensor body 41. Therefore, the vibrations corresponding to striking the rim portion can be prevented from being detected by the sensor body 41.

Furthermore, in the percussion instrument 1 of this embodiment, the two fixing members 93 that fix the support plate portion 42 of the head sensor 4 to the connection portion 30 are located on both sides of the sensor body 41 of the head sensor 4 in the circumferential direction D3. Therefore, compared to the case where the two fixing members 93 are located on both sides of the sensor body 41 in the radial direction D2, the head sensor 4 attached to the connection portion 30 can be located closer to the body portion 10 or closer to the support portion 20.

Although the present disclosure has been described in detail above, the present disclosure is not limited to the above embodiment, and various modifications can be made without departing from the scope of the present disclosure.

In the present disclosure, the three head sensors 4 (4A to 4C) are not limited to being attached to the connection portion 30 with mutually different structures as in the above embodiment, but may be attached to the connection portion 30 with, for example, a common structure.

Specifically, for example, by arranging the control board 5 at a position different from the second connection portion 30B (for example, the support portion 20), the structure for attaching the second head sensor 4B to the second connection portion 30B may be the same as the structure for attaching the first head sensor 4A to the first connection portion 30A as shown in FIG. 8. In addition, by positioning the clamping structure 35C that clamps the rod-shaped member 9 on the outside of the body and excluding the clamping structure 35C from the third connection portion 30C, the structure for attaching the third head sensor 4C to the third connection portion 30C may be the same as the structure for attaching the first head sensor 4A to the first connection portion 30A as shown in FIG. 8. That is, the mounting structure for all of the three head sensors 4 (4A to 4C) may be a structure as shown in FIG. 8 in which the first head sensor 4A is attached to the first connecting portion 30A.

Alternatively, the mounting structure for all of the three head sensors 4 (4A-4C) may be a structure as shown in FIG. 9 in which the second head sensor 4B is attached to the second connection portion 30B, or a structure as shown in FIG. 10 in which the third head sensor 4C is attached to the third connection portion 30C.

Moreover, the mounting structure of the three head sensors 4 (4A-4C) may adopt any two of the following mounting structures: a mounting structure of the first head sensor 4A to the first connection portion 30A as shown in FIG. 8, a mounting structure of the second head sensor 4B to the second connection portion 30B as shown in FIG. 9, and a mounting structure of the third head sensor 4C to the third connection portion 30C as shown in FIG. 10.

In the present disclosure, the mounting structures of the head sensors 4 (4A-4C) and the mounting structure of the rim sensor 3 are not limited to the structures described above, and may be other structures.

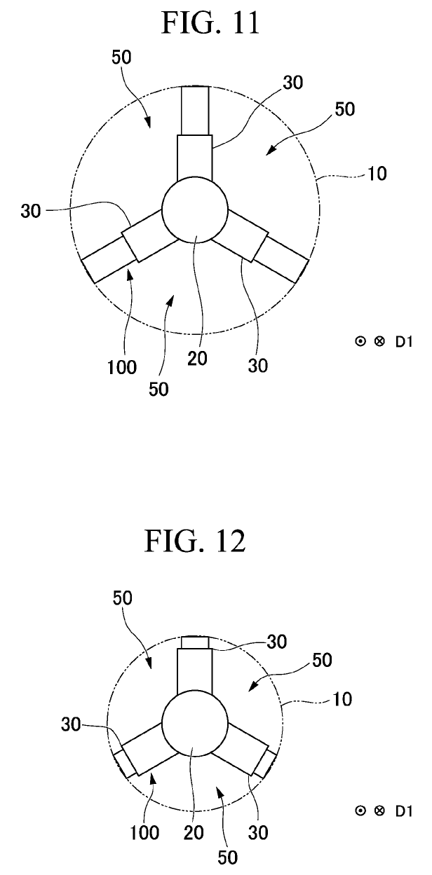

In the percussion instrument of the present disclosure, for example, the support portion 20 and the connection portion 30 may be formed separately from the body portion 10, and may be attached to the inside of the body portion 10 as viewed from the axial direction D1. In this case, the percussion instrument may have a length adjustment mechanism 100 for adjusting the length of the connection portion 30 extending from the support portion 20, as shown in, for example, FIG. 11 and FIG. 12. The length adjustment mechanism 100 shown in FIG. 11 and FIG. 12 adjusts the length of all the connection portions 30. The length adjustment mechanism 100 may be configured to adjust the length of at least one connection portion.

In a percussion instrument having a length adjustment mechanism 100 as shown in FIG. 11 and FIG. 12, a unit including the support portion 20 and the connection portion 30, as well as the rim sensor 3, the head sensor 4, the control board 5, etc. attached thereto, can be attached to various types of body portions 10 (for example, the body portion 10 of an acoustic drum). In particular, the unit can be attached to body portions 10 of various diameters. For example, as shown in FIG. 11, when the length of the connection portion 30 is adjusted to be long, the unit can be attached to the body portion 10 with a large diameter. On the other hand, as shown in FIG. 12, when the length of the connection portion 30 is adjusted to be short, the unit can be attached to the body portion 10 with a small diameter.

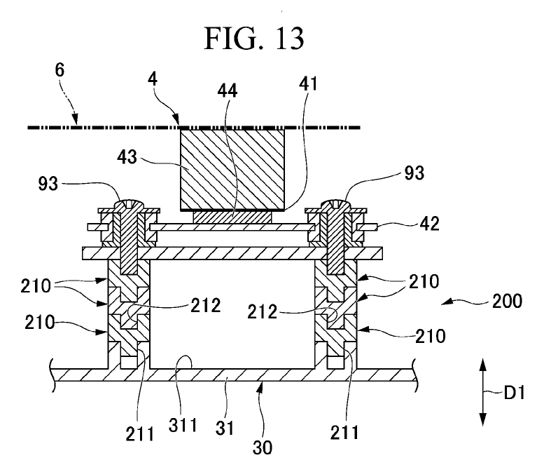

In addition, when the support portion 20 and the connection portion 30 are formed separately from the body portion 10, and can be attached to the inside of the body portion 10 as viewed from the axial direction D1, the percussion instrument may have a height adjustment mechanism that adjusts the height of the head sensor 4 in the axial direction D1, based on the connection portion 30. There are various types of height adjustment mechanism, and for example, it may have the height adjustment mechanism 200 shown in FIG. 13.

As shown in FIG. 13, the height adjustment mechanism 200 may be composed of for example, spacers 210 that can be interposed between the connection portion 30 and the head sensor 4. The height position of the head sensor 4 may then be adjusted depending on the number of spacers 210 interposed between the connection portion 30 and the head sensor 4.

The spacers 210 illustrated in FIG. 13 have a male threaded portion 211 and a female threaded portion 212. The spacer 210 can be placed on the connection portion 30 by screwing the male threaded portion 211 of the spacer 210 into the female threaded portion formed in the connection portion 30. In addition, the number of spacers 210 overlapping on the connection portion 30 can be increased by screwing the male threaded portion 211 of another spacer 210 into the female threaded portion 212 of the spacer 210.

Then, when a screw as the fixing member 93 is passed through the head sensor 4 (support plate portion 42) and then screwed into the female threaded portion of the connection portion 30, the head sensor 4 can be directly attached to the connection portion 30. On the other hand, when a screw as the fixing member 93 is passed through the head sensor 4 (support plate portion 42) and then screwed into the female threaded portion 212 of the spacer 210 attached to the connection portion 30, the head sensor 4 can be attached to the connection portion 30 via the spacer 210.

In a percussion instrument having a height adjustment mechanism 200, a unit including a support portion 20, a connection portion 30, a rim sensor 3, a head sensor 4, a control board 5, etc. can be attached to various types of body portions 10 (for example, body portions 10 of acoustic drums). In particular, it becomes possible to attach the unit to body portions 10 of various height dimensions (dimensions in the axial direction D1). For example, when attaching the unit to a body portion 10 with a large height dimension, the height position of the head sensor 4 from the connection portion 30 can be adjusted higher by the height adjustment mechanism 200, so that the head sensor 4 can be appropriately in contact with the head 6. Also, for example, when attaching the unit to a body portion 10 with a small height dimension, the height position of the head sensor 4 from the connection portion 30 can be adjusted lower by the height adjustment mechanism 200, so that the head sensor 4 can be appropriately in contact with the head 6.

In the present disclosure, the reinforcing member of the connection portion 30 (the second reinforcing member 34B and the housing 36C in the above embodiment) is not limited to being fixed to the connection plate portion 31 by screwing, and may be fixed to the connection plate portion 31 by other methods, such as an adhesive.

In addition, the reinforcing member of the connection portion 30 is not limited to being formed separately from the connection plate portion 31 and fixed to the connection plate portion 31, and may be formed integrally with the connection plate portion 31, for example.

In the present disclosure, the second connection portion 30B and the third connection portion 30C, for example, similar to the first connection portion 30A, may have only a rib protruding from the opposing surface 311 of the connection plate portion 31 and extending from the support portion 20 to the body portion 10, as the main structure for reinforcing the connection plate portion 31. Also, the first connection portion 30A and the third connection portion 30C may have only a reinforcing member arranged on the opposing surface 311 side of the connection plate portion 31 as the main structure for reinforcing the connection plate portion 31, similar to, for example, the second connection portion 30B. Also, the first connection portion 30A and the second connection portion 30B may have the above-mentioned rib and reinforcing member as the main structure for reinforcing the connection plate portion 31, similar to, for example, the third connection portion 30C. That is, the structure for reinforcing the connection plate portion 31 may be the same among, for example, the plurality of connection portions 30.

In the present disclosure, the number of fixing members 93 that fix the support plate portion 42 of the head sensor 4 to the connection portion 30 is not limited to two, and may be, for example, three or more.

In the present disclosure, the control board 5 does not have to be covered by, for example, a reinforcing member.

Also, the control board 5 is not limited to being attached to the connection portion 30, and may be attached to, for example, the support portion 20. In this case, the control board 5 may be disposed on the support surface 201 side of the support portion 20.

The present disclosure is not limited to application to drums, but may also be applied to other percussion instruments (e.g., bongos, congas) that can have a head attached to at least the open end of the body.

According to the present disclosure, it is possible to suppress changes in the feel of the head caused by the material of the head, thereby improving the playability of the percussion instrument.

While preferred embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

WHAT IS CLAIMED IS:

1. A percussion instrument comprising:
a body portion having a cylindrical shape, the body portion having an opening, on a first side of the body portion in an axial direction, to which a head is attached;
a rim sensor configured to detect an impact on a rim portion of the body portion;
a head sensor configured to detect an impact on the head;
a support portion supporting the rim sensor and being located within the body portion while being spaced apart from a wall of the body portion when viewed from the axial direction, the support portion also being spaced apart from the head and facing the head in the axial direction;
a plurality of connection portions, each of the plurality of connection portions extending from the support portion to the body portion and connecting the support portion and the body portion, the plurality of connection portions being arranged at intervals in a circumferential direction of the body portion; and
a plurality of opening portions that open to a second side of the body portion opposite to the first side of the body portion in the axial direction and that are respectively disposed between each of the plurality of connection portions,
wherein the head sensor is attached to at least one connection portion of the plurality of connection portions and contacts the head.

2. The percussion instrument according to claim 1,
wherein the at least one connection portion attached to the head sensor includes:
a connection plate portion extending from the support portion to the body portion, a thickness direction of the connection plate portion being aligned with the axial direction; and
a rib protruding from a surface of the connection plate portion facing the head and extending from the support portion to the body portion.

3. The percussion instrument according to claim 1,
wherein at least one connection portion attached to the head sensor includes:
a connection plate portion extending from the support portion to the body portion, a thickness direction of connection plate portion being aligned with the axial direction; and
a reinforcing member arranged on a side of a surface of the connection plate portion facing the head.

4. The percussion instrument according to claim 3, further comprising:
a control board configured to control an operation of the rim sensor and an operation of the head sensor,
wherein the control board is arranged between the connection plate portion and the reinforcing member and is covered by the reinforcing member.

5. The percussion instrument according to claim 1, further comprising:
a plurality of protective portions respectively extending, as seen from the axial direction, from edges of the support portion and the plurality of connection portions that form edges of the plurality of opening portions, to the first side of the body portion in the axial direction.

6. The percussion instrument according to claim 1, further comprising:
a cushioning material disposed between the head sensor and the at least one connection portion and configured to absorb vibrations of the at least one connection portion.

7. The percussion instrument according to claim 1,
wherein the head sensor includes a sensor body and a support plate portion that supports the sensor body,
wherein the support plate portion is fixed to the at least one connection portion by at least two fixing members, and
wherein the at least two fixing members are located on both sides of the sensor body in the circumferential direction of the body portion.

8. The percussion instrument according to claim 1,
wherein the support portion and the at least one connection portion are formed separately from the body portion and are attached to an inside of the body portion as viewed from the axial direction, and
wherein the percussion instrument further comprises a length adjustment mechanism configured to adjust a length of the at least one connection portion.

9. The percussion instrument according to claim 1,
wherein the support portion and the at least one connection portion are formed separately from the body portion and are attached to an inside of the body as viewed from the axial direction, and
wherein the percussion instrument further comprises a height adjustment mechanism configured to adjust a height of the head sensor in the axial direction with the at least one connection portion serving as a reference.
